(19) United States
(12) Patent Application Publication
(10) Pub. No.: US 2025/0247570 A1
(43) Pub. Date: Jul. 31, 2025

(54) SYSTEM AND METHOD FOR GENERATING ENCAPSULATED VIDEO USING AI MODEL

(71) Applicant: Idomoo LTD, Raanana (IL)

(72) Inventors: Danny KALISH, Raanana (IL); Dan SHAMIR, Raanana (IL)

(21) Appl. No.: 19/041,783

(22) Filed: Jan. 30, 2025

Related U.S. Application Data
(60) Provisional application No. 63/626,582, filed on Jan. 30, 2024.

(51) Int. Cl. H04N 21/2343; H04N 21/236; H04N 21/25

(52) U.S. Cl. CPC H04N 21/2343; H04N 21/236; H04N 21/251

(57) ABSTRACT

The present invention provides a method for generating video template using AI model implemented by one or more processors operatively coupled to a non-transitory computer readable storage device, on which are stored modules of instruction code that when executed cause the one or more processors to perform the steps of:
Training Ai model to generate encapsulated video template from user input wherein the encapsulated video is defined by video rules, media unit rules and parameters and object's parameters;
   Applying trained AI model to generate encapsulated video based on user input by determining video rules, media unit rules and parameters and object's parameters;

### FIELD OF THE INVENTION

The present invention relates generally to generations of context-based video. More particularly, the present invention relates to generating encapsulated video using AI models.

### BACKGROUND OF THE INVENTION

### Summary of the Invention

The present invention provides a method for generating encapsulated video using AI model implemented by one or more processors operatively coupled to a non-transitory computer readable storage device, on which are stored modules of instruction code that when executed cause the one or more processors to perform the steps of:
training unified Training Ai model to generate encapsulated video from user input wherein the encapsulated video is defined by video rules, media unit rules, and object's parameters and design rules;
applying unified trained AI model to generate encapsulated video based on user input by determining video rules, media unit rules object's parameters and design rules.

According to some embodiments of the present invention the objects parameters include Material object parameters, Motion parameters, Camera positions and/or movement by applying a set of camera rules.

According to some embodiments of the present invention the Selection customization rule includes rules that apply to parameters which determine the media units to be displayed and the order of media unit appearance.

According to some embodiments of the present invention the material parameters including properties of objects including at least one: color, position, visibility, shape, size or orientation.

According to some embodiments of the present invention Motion parameters are determining motion rules of objects in relation to each video frame or group of frames, wherein the motion rules define route or movement pattern in space.

According to some embodiments of the present invention the camera rules include Appearance customization rules, Video customization rules, Selection rules of objects or scene, rules that apply to parameters which have a visible effect on the video According to some embodiments of the present invention each media object type may require a different optimal compression rule.

The present invention provides A method for generating encapsulated video using AI model implemented by one or more processors operatively coupled to a non-transitory computer readable storage device, on which are stored modules of instruction code that when executed cause the one or more processors to perform the steps of:
training multiple Ai model to generate encapsulated video from user input wherein the encapsulated video is defined by video rules, media unit rules and parameters and object's parameters, wherein each model is trained for different aspect of the of the encapsulated video;
applying trained AI models to generate encapsulated video based on user input by determining video rules, media unit rules and parameters. object's parameters and design rules and parameters.

According to some embodiments of the present invention one AI model is for training video rules based on user text or given script for generating encapsulated video by learning more user feedback;

According to some embodiments of the present invention one AI model is for training selection of Media units based on user text or given script for generating encapsulated video by learning more user feedback.

According to some embodiments of the present invention one AI model is for object parameters based on user text or given script for generating encapsulated video by learning more user feedback.

The present invention provides A method for generating encapsulated video using AI model implemented by one or more processors operatively coupled to a non-transitory computer readable storage device, on which are stored modules of instruction code that when executed cause the one or more processors to perform the steps of:
Training first AI model for training video rules based on user text or given script for generating encapsulated video by learning by learning more user feedback.
Training second Training AI model for training selection of Media units based on user text or given script for generating encapsulated video by learning more adapted/successful (based on user feedback or showing statistics).
Training object parameters third AI model for object parameters based on user text or given script for generating encapsulated video by learning more user feedback;
Training fourth AI model for Determining design layout rules and parameters including at least one of: video layers, number of media units, text, layout of objects, composition, timing, animation, effect or motion blare
applying trained AI models to generate encapsulated video based on user input by determining video rules, media unit rules and parameters object's parameters and design rules and parameters.

According to some embodiments the objects parameters including Material parameters, Motion parameters, Camera positions and/or movement by applying set of camera rules, wherein the rule include Appearance customization rules, Video customization rules, Selection rules of objects or scene.

According to some embodiments the video rules include Appearance customization rules: Rules that apply to parameters which have a visible effect on the video, e.g.: inserting a specific username or image in the video sequence.
Selection customization rules: Rules that apply to parameters which determine the media units to be displayed and the order of media unit appearance.

Video customization rules may be applied to media units either dynamically or statically;
a. Dynamically-media units are presented according to environment parameters (e.g. time of day), Context, and user profile parameters (e.g. name of logged in user on the presenting machine).
b. Statically-media units are presented according to predefined global and constant parameters.

Selection rules may be applied to media units either dynamically or statically;
c. Dynamically-media units are selected to be presented, and their order is sorted according to environment parameters, Context, and user profile parameters.
Wherein these parameters include at least one of:
d. Material parameters including properties of objects, e.g.: color, position, visibility, shape, size, orientation, etc.
e. Special effects parameters, e.g.: lighting, shading, opacity, 3D etc.
f. Motion parameters: determining motion rules of objects in relation to each video frame or group of frames; the motion rules may define route or movement pattern in space.
g. Camera positions and/or movement, light projection
h. Binary data container: importing objects data or links to objects.
Each media object type may require a different optimal compression rule;

The present invention provides a method for generating customizable and encapsulated media files based predefined basic media content. The method comprising:
determining at least one media unit for encapsulation, each media unit comprising a basic media content constructed from video frames and media objects, wherein each frame is constructed of static layers and dynamic layers;
defining media objects of each media unit;
defining properties of each defined media object for each frame in the video based on defined dynamic motion rules and defined customization rules;
creating an encapsulated media file containing the at least one media unit and multiple parameter types of data thereof, said encapsulated media file being configured for de-capsulation thereof for playing content thereof by generating the video frames based on the object's parameter data, according to the defined parameters data, defined customization rules of static object properties;
wherein at least one of determining, constructing, defining or creating is performed by at least one processor.

According to some embodiments of the present invention the method further comprises the step of defining each media unit as static of dynamic.

According to some embodiments of the present invention defining of said parameters further include define extension functionalities

According to some embodiments of the present invention defining of said parameters include define shader parameters of 3D effects.

According to some embodiments of the present invention defining of said parameter further include ad binary data of alternative or additional objects or ad external resources links to objects

According to some embodiments of the present invention the method further comprising the step of determining media units to be played and order of playing based on organization, selection rules using customization parameters retrieved from user profile or entered by the user.

According to some embodiments of the present invention the method further comprises the step of applying compression algorithm on objects data according to pre-defined rules in relation to object type.

The present invention provides a method of video generating customized video from an encapsulated video file. The method comprising the steps of:
reading from parameters encapsulation data including at least: material information of objects properties from project data of encapsulated filed;
retrieving binary data of objects from encapsulated file or external resources based on network address included in the encapsulated file;
reading relevant customization rules from the encapsulated file;
generating frames by applying generic video script on the object binary data and properties, wherein at each frame are used selected objects properties based on customization rules for dynamic object properties and on target user or environment characteristics;
integrating generated video files into a single sequence of video streams.

According to some embodiments of the present invention the generating at least one video file or stream, comprise the following steps:
a. modifying premade media units based on retrieved customization rules;
b. define motion pattern of objects or location of object on the screen layout by applying dynamic data objects motion rules; and
c. modifying objects properties based on target user profile or environment characteristics.

According to some embodiments of the present invention the method further comprises the step of applying de-compression according to object type based on predefined rules for each object type.

The present invention provides a system video generating customized video from an encapsulated video file. The system comprised of:
preparation module determining at least one media unit for encapsulation, each
media unit comprising a basic media content constructed from video frames, wherein each frame is constructed of static layers and dynamic layers;
wherein for each of said determined media unit frames and layers, defining properties of each defined media object for each frame in the video based on defined dynamic motion rules and defined customization rules; and;
builder module for creating an encapsulated media file containing the at least one media unit and multiple parameter types of data thereof, said encapsulated media file being configured for de-capsulation thereof for playing content thereof by generating the video frames based on the object's parameter data, according to the defined parameters data, defined customization rules of static object properties.

According to some embodiments of the present invention the method further comprising organization module to determine media units to be played and order of playing based on organization and selection rules based on customization parameters retrieved from user profile or entered by the user.

According to some embodiments of the present invention, each video can be defined as static of dynamic.

According to some embodiments of the present invention the encapsulation further includes defining extension functionalities.

According to some embodiments of the present invention the encapsulation further includes defining shader parameters of 3D effects.

According to some embodiments of the present invention the system comprising the step of ad binary data of alternative or additional objects or ad external resources links to objects

According to some embodiments of the present invention the user is enabled to add binary data of alternative or additional objects.

The present invention provides a method for generating customizable and encapsulated media files, said method comprising:
(a) determining at least one media unit for encapsulation, each media unit comprising a basic media content;
(b) for each of said determined media unit, defining multiple data layers, each layer being associated with a different data type,
wherein said defining of said layers comprises:
   (i) defining media objects of each media unit;
   (ii) defining properties of each defined media object;
   (iii) defining customization rules for said determined at least one media unit;
   (iv) defining dynamic motion rules for at least one of said defined media objects,
      and
(c) creating an encapsulated media file containing at least one media unit and data layers thereof, said encapsulated media file being configured for de-capsulation thereof for playing content thereof, according to the defined layers thereof.

These, additional, and/or other aspects and/or advantages of the present invention are set forth in the detailed description which follows; possibly inferable from the detailed description; and/or learnable by practice of the present invention.

According to some embodiments, the method further comprises the step of defining each media unit as static or dynamic.

According to some embodiments, the defining of said layers further comprises defining extension functionalities.

According to some embodiments, the defining of said layers further comprises defining shader parameters of 3D effects.

According to some embodiments, the method further comprises the step of adding binary data of alternative or additional objects and/or adding external resources links to objects.

According to some embodiments, the method further comprises the step of determining a media unit to be played and order of playing based on at least one of: organization, selection rules using customization parameters retrieved from user profile or entered by the user.

According to some embodiments, the method further comprises the step of applying a compression algorithm on objects data according to pre-defined rules in relation to object type.

The present invention also provides a method for generating customized videos from encapsulated video files, said method comprising the steps of: (i) reading from a multilayer encapsulated information including at least: material information of objects properties from project data of encapsulated filed; (ii) retrieving binary data of objects from encapsulated file or external resources based on network address included in the encapsulated file; (iii) reading relevant customization rules from the encapsulated file; (iv) generating at least one video file or stream by applying retrieved customization rules using objects binary data and objects properties based on target user or environment characteristics; and (v) integrating generated video files into a single sequence of video stream.

According to some embodiments, generation of at least one video file or stream, is comprised of the following steps: (a) modifying media based on retrieved customization rules; (b) define motion pattern of objects or location of object is the screen layout by applying dynamic layer data objects motion definitions; and (c) modifying objects properties based on target user profile or environment characteristics.

According to some embodiments, the method further comprises the step of applying de-compression according to object type based on predefined rules for each object type.

The present invention further provides a system for generating customized video from encapsulated video files, said system comprising: (i) retrieving module for reading information from multi data layer of encapsulated file by at least reading material information of objects properties from project data of encapsulated file, binary data of objects from encapsulated file or external resources using provided network address and reading relevant customization rules from the encapsulated file; and (ii) creation module for generating at least one video file or stream by applying retrieved customization rules using objects binary data and objects properties based on target user or environment characteristics and integrating generated video files into a single sequence of video stream.

According to some embodiments, the system further comprises an organization module configured to determine media units to be played and order of playing based on organization and selection rules based on customization parameters retrieved from user profile or entered by the user.

According to some embodiments, each media unit can be defined as either static or dynamic.

According to some embodiments, the encapsulation further comprises defining extension functionalities.

According to some embodiments, the encapsulation further comprises defining shader parameters of 3D effects.

According to some embodiments the method further comprising the step of ad binary data of alternative or additional objects or ad external resources links to objects.

According to some embodiments the designer can add binary data of alternative or additional objects.

### DESCRIPTION OF THE DRAWINGS

The present invention will be more readily understood from the detailed description of embodiments thereof made in conjunction with the accompanying drawings of which:

FIG. 1 is a block diagram showing components and environment of a system for generating encapsulated video file, according to some embodiments of the invention;

FIG. 2 is a block diagram showing components and environment of a system AI models, according to some embodiments of the invention;

FIG. 3A is a diagram of encapsulated video file format, according to some embodiments of the invention;

FIG. 3A is a diagram of encapsulated video file structure, according to some embodiments of the invention;

FIG. 4A is a flowchart diagram of Encapsulated Video builder module, according to some embodiments of the invention;

FIG. 4B is a block diagram of Encapsulated Video builder module, according to some embodiments of the invention;

FIG. 5 is a flowchart diagram showing a process carried out by a Video encoder module, according to some embodiments of the invention; and

FIG. 6A is a block diagram of Video decoder-generator module in association with the relevant modules, according to some embodiments of the invention

FIG. 6B is a flowchart diagram showing a process carried out by a video decoder-generator module, according to some embodiments of the invention.

FIG. 7 is a flowchart diagram showing a process carried out by Ai MODEL training for generating encapsulated video module, according to some embodiments of the invention.

FIG. 8 presents a flowchart diagram outlining a method User interface 900 for generating an encapsulated video module. This process is designed in accordance with certain embodiments of the invention;

### DETAILED DESCRIPTION OF SOME EMBODIMENTS OF THE INVENTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention relates to a new format of encoded video data. This new format facilitates the creation of video content in multiple variations and on-the-fly generation of customized and personalized video files. The present invention includes:
builder software and interface: Creating and customizing encapsulated video files.
A video encoding module: Producing compressed video data in the said format, or in other industry acknowledged video formats.
The said video format: Encompassing video content and customization data.
A decoder module: Enabling streaming video playback of the said video format.
A dedicated media player, as an optional viewer of the said video format

The following is a table of definitions of the terms used throughout this application, adjoined by their properties and examples.

| Term | Definition | Properties | Example |
|---|---|---|---|
| Media | Basic building block of | Material properties of | Blue triangle |
| Object | video media unit. | objects for each frame for | |
| | | each layer of media units, | |
| | | e.g. color, position, | |
| | | visibility, opacity, shape, | |
| | | size etc. | |
| | | Motion properties | |
| | | Special effects properties, | |
| | | e.g.: lighting, shading etc. | |
| | | Each object type may | |
| | | require a different optimal | |
| | | compression rule. | |
| | | May be replaced by a | |
| | | “Binary data container”, | |
| | | i.e.: objects or links to | |
| | | objects | |
| Media | Motion parameters: object's | | |
| Object | motion in relation to each | | |
| configuration | video frame layers or group | | |
| parameters | of frames. | | |
| | Material parameters: | | |
| | properties of objects for | | |
| | each frame, e.g.: color, | | |
| | position, visibility, shape, | | |
| | size | | |
| | Lighting and special | | |
| | effects, e.g. shading | | |
| Media | Basic block of a displayable | Customization according | Blue triangle |
| Unit | video sequence. | to Dynamic and static | flying from |
| | comprised of video frames, | configurations | left to right, |
| | each frame comprised of | | presenting the |
| | dynamic and static layers | | username and |
| | Comprised of media objects | | time of day. |
| | (see above), this is the basic | | |
| | building block of an | | |
| | encapsulated video file (see | | |
| | below). | | |
| | Media units may be | | |
| | customized either statically | | |
| | or dynamically layers of | | |
| | frames below) to diversify | | |
| | the production of multiple | | |
| | video files | | |
| Video | Comprised of dynamic and | | |
| frame | static layers | | |
| | Each layer comprised of | | |
| | media object | | |
| Media | Environment parameters | Environment media unit | Environment |
| Unit | Context parameters | parameters enable | parameters: |
| configuration | User profile parameters | diversifying the video | show lighting |
| parameters | | presentation according to | according to |
| | | external information | the actual time |
| | | sources: | of day. |
| | | Context media unit | Context |
| | | parameters enable | parameters: |
| | | diversifying the video | Personalization |
| | | presentation according to | parameters: |
| | | user profile parameters | “Hello Mr. |
| | | User profile media unit | Smith. Here is |
| | | parameters enable | your schedule |
| | | diversifying the video | for today . . . ” |
| | | presentation according to | |
| | | user profile parameters: | |
| | | name, age, gender, | |
| Extension | Parameters that apply | Global lighting, Global | Shine all |
| functionalities | globally to all media | shading, | objects from a |
| | objects that reside | Global motion | specific angle |
| | hierarchically under a | | |
| | specific media unit. | | |
| Encapsulated | A file format comprised of | Encapsulated video | If played on a |
| video file | one or more media units. | parameters (select and sort | Sunday, |
| | This format Includes | media units) | present media |
| | additional customization | Video Project information | unit #1 before |
| | parameters for: | | media unit #2. |
| | • static or dynamic | Metadata | Otherwise - |
| | selection of media | | reverse |
| | units to display. | | playback |
| | • static or dynamic | | order. |
| | sorting of media | | |
| | units. | | |
| Encapsulated | A software tool and UI, | Backend | |
| video | designed to assemble and | | |
| Builder | compile Encapsulated video | | |
| | files, encompassing all the | | |
| | information as described | | |
| | above. | | |
| Dynamic | Dynamic - media units are | | |
| Vs. Static | presented according to | | |
| customization | environment parameters | | |
| parameters | (e.g. time of day), Context | | |
| | or user profile | | |
| | configuration parameters | | |
| | (e.g. name of logged in user | | |
| | on the presenting machine). | | |
| | Static - media units are | | |
| | presented according to | | |
| | predefined, global and | | |
| | constant parameters. | | |
| Selection | Video customization | | If user's age is |
| customization | parameters that determine | | below 6 years |
| parameters | the selection and ordering | | - show |
| | of media units | | “Sesame |
| | | | Street” |
| Appearance | Video customization | | If user is a boy |
| customization | parameters that affect the | | - show blue |
| parameters | video appearance, e.g .: | | background, |
| | inserting a name, picture | | otherwise |
| | etc. | | show pink |
| | | | background |
| Video | A service designed to | | |
| customization | provide a mechanism for | | |
| server | dynamically changing | | |
| Encoder | customization parameters | | |
| | A software module, | | |
| | designed to encode | | |
| | encapsulated video file | | |
| | formats. | | |
| | The encoder compresses | | |
| | the encapsulated video file | | |
| | according to the type and | | |
| | content of each resident | | |
| | media object, to achieve | | |
| | optimum compression | | |
| | ratios | | |
| Decoder | A software module, | Frontend, UI | |
| | designed to present | | |
| | encoded encapsulated video | | |
| | files. | | |
| | The Decoder can produce | | |
| | video data either as: | | |
| | 1 A video file of other | | |
| | industry acknowledged | | |
| | format (e.g. MPEG4) or | | |
| | 2 A direct video stream | | |

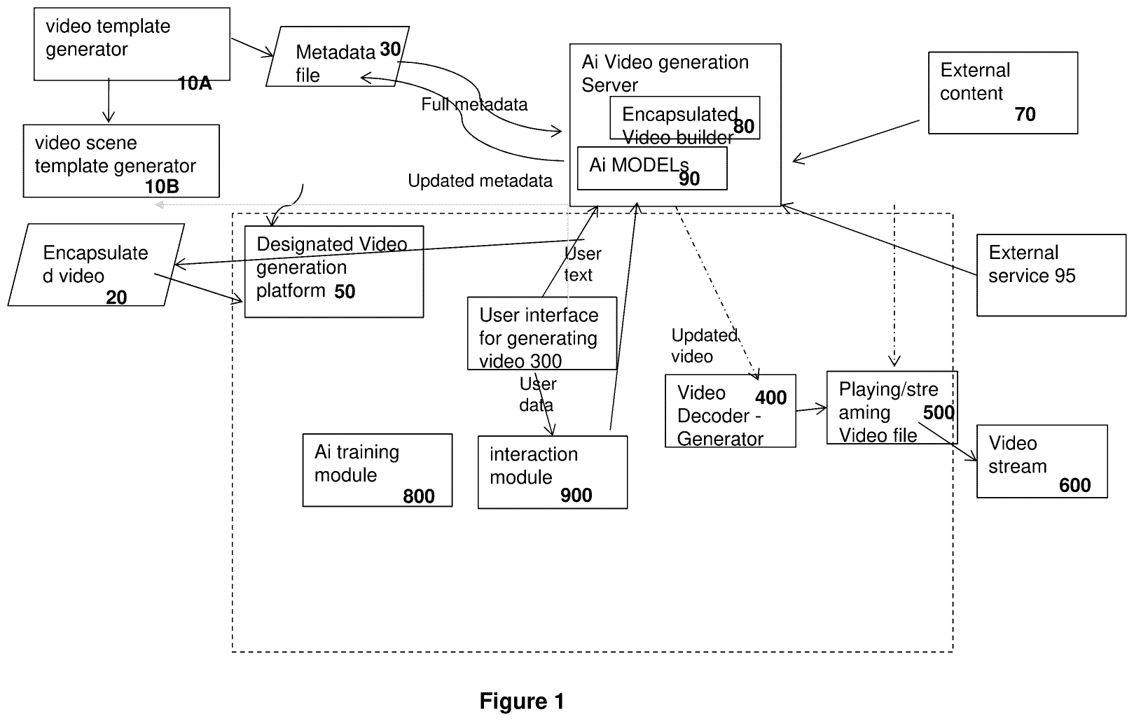

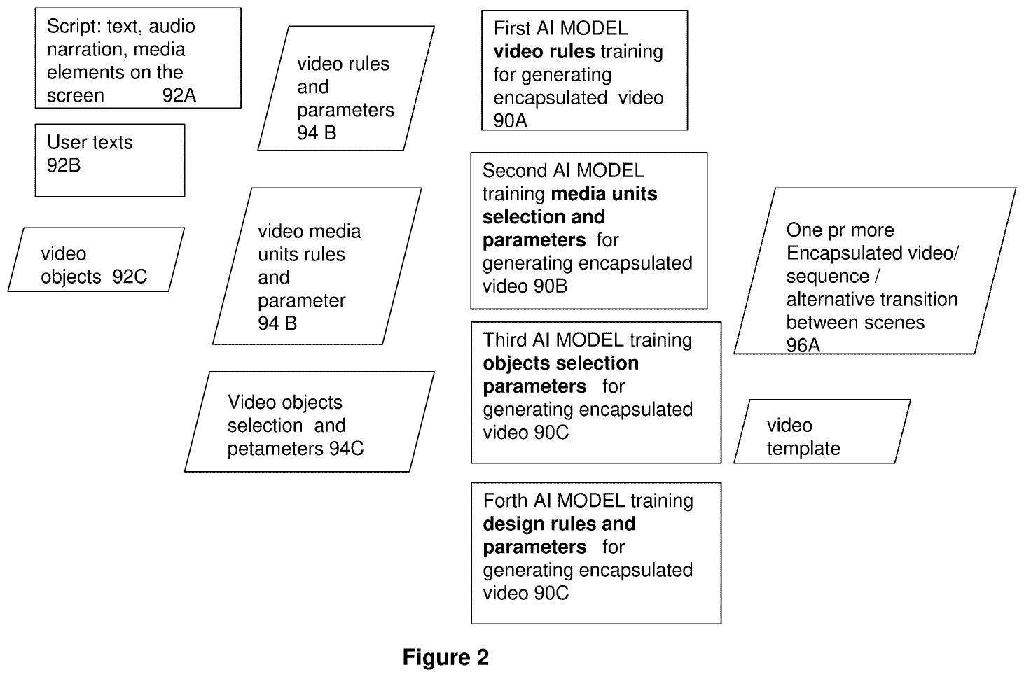

FIG. 1 is a block diagram of the components and the environment of a system for generating encapsulated video files and decapsulation thereof for playing content thereof, according to some embodiments of the invention. The system according to the present invention includes:
An Encapsulated video Builder [80], enabling creation of encapsulated video files based on video media units [100], and customization rules. These customization rules may be introduced either via the Builder's interface [150], or via a video customization rules' server [600]. Optionally using external content 70 or external services 95
A video Encoder [300], Enables the creation of encoded (i.e. compressed, transferable, encapsulated video) files. These files are stored in an Encapsulated Video files' repository.
A video decoder-generator [400], for creating playable customized video files [100C] or producing a video stream playback [100D] of the encapsulated video files. The Video Decoder-generator may also use external resources of video data [700].
A designated Video player [900], for playing customized decoded video files [100B] based on the encapsulated video or providing customized video streams 100D.
Ai models 90 for generating encapsulated video, as further described in FIG. 2;
Ai training modules 800;
interaction module 900 configured to chat with AI models;

According to some embodiments, encapsulated video files [100B] may originate from any third-party tool which adopts the encapsulation format as disclosed by the present invention.

FIG. 2 is a block diagram showing components and environment of a system AI models, according to some embodiments of the invention;

Three AI models are trained based on received script: text, audio narration, media elements on the screen 92A, User texts 92B and video objects 92C.

The models are training the following: video rules and parameters 94 B, video media units' rules and parameter 94 B or Video objects selection and parameters 94C.

### Training of Four Distinct AI Models

The system involves training three specialized AI models, each focusing on different aspects of video creation:

The first AI model (Model 90A) is specifically trained to generate encapsulated videos by applying video rules. This model focuses on the structural and stylistic aspects of video creation.

The second AI model is specifically trained to generate encapsulated videos by determining Media Units Rules and Parameters (Model 90B): Another facet of training involves understanding the rules and parameters specific to various media units, enhancing the model's ability to create cohesive and well-structured videos.

The third AI model: is specifically trained to generate encapsulated videos by Video Object Selection and Parameters (Model 90C): This training aspect focuses on the selection of video objects and their parameters, allowing for detailed customization and relevance in the video content.

The fourth is specifically trained to generate encapsulated videos by design rules and parameter.

Each AI model undergoes specific training to master distinct aspects of video creation.

The collective output from these models includes a range of encapsulated videos (Output 96A). These videos offer multiple options with alternative transitions between scenes, providing a variety of choices that cater to different user preferences and requirements.

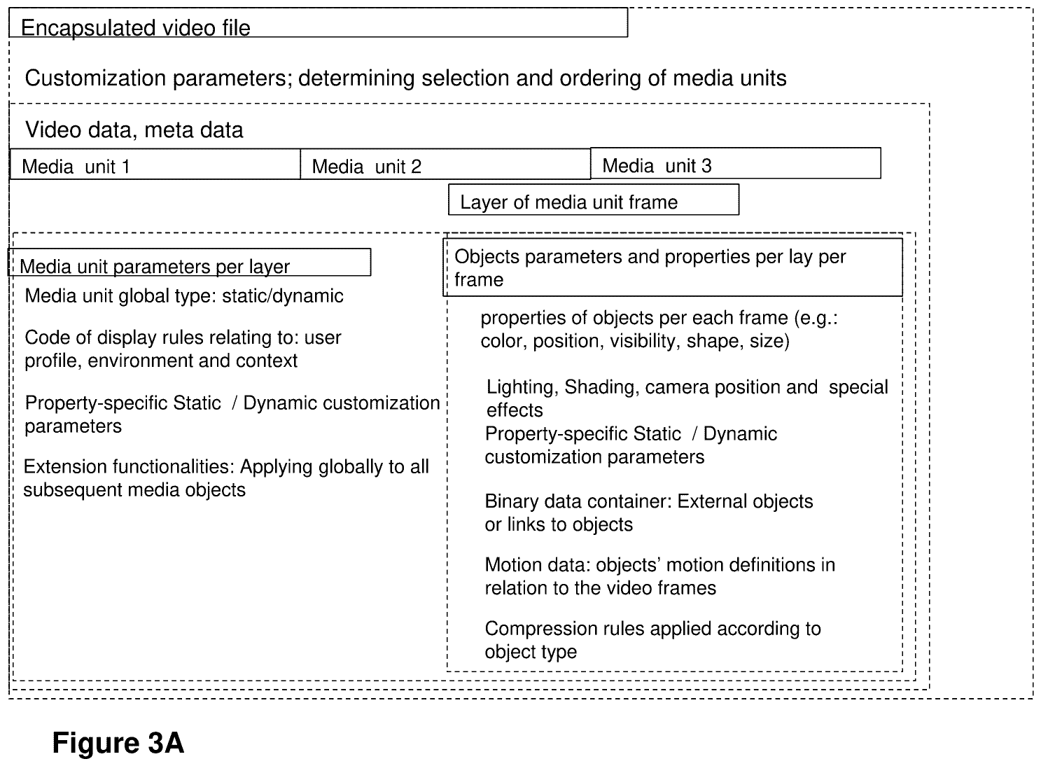

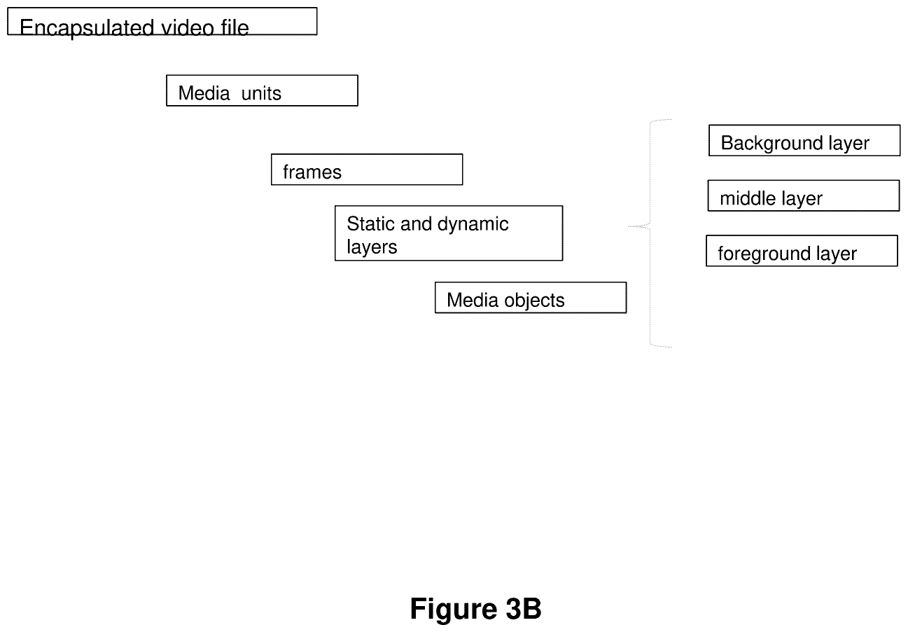

FIG. 3A is a diagram of the encapsulated video file format, according to some embodiments of the invention. The encapsulated file format is comprised of at least one media unit. The media unit is comprised of video frames, each frame comprised of static and dynamic layers, each layer having at least one media object (e.g. image). The encapsulated file format also includes file metadata, media unit and media object customization data.

The media unit configuration parameters may be applied to determine rules for video selection, ordering and appearance. These parameters are categorized by:
a. User profile data, e.g.: age, gender or user preferences
b. Current context, e.g.: location,
c. Environmental data, e.g.: time of day, temperature etc.

There are two types of media unit customization rules. These rules are set according to the user profile, current context and environment data:
a. Appearance customization rules: Rules that apply to parameters which have a visible effect on the video, e.g.: inserting a specific username or image in the video sequence.
b. Selection customization rules: Rules that apply to parameters which determine the media units to be displayed and the order of media unit appearance.

Video customization rules may be applied to media units either dynamically or statically;
a. Dynamically-media units are presented according to environment parameters (e.g. time of day), Context, and user profile parameters (e.g. name of logged in user on the presenting machine).
b. Statically-media units are presented according to predefined global and constant parameters.

Selection rules may be applied to media units either dynamically or statically;
a. Dynamically-media units are selected to be presented, and their order is sorted according to environment parameters, Context, and user profile parameters.
b. Statically-media units are selected to be presented, and their order is sorted according to predefined global and constant parameters.

Media objects are attributed a dedicated set of parameters. These parameters include:
a. Material parameters including properties of objects, e.g.: color, position, visibility, shape, size, orientation, etc.
b. Special effects parameters, e.g.: lighting, shading, opacity, 3D etc.
c. Motion parameters: determining motion rules of objects in relation to each video frame or group of frames; the motion rules may define route or movement pattern in space.
d. Camera positions and/or movement, light projection, defined by camera rules;
e. Binary data container: importing objects data or links to objects.
f. Each media object type may require a different optimal compression rule;

According to some embodiments of the present invention, the video encapsulation format as suggested by the present invention may be used by a third-party video tool by adapting the encapsulated format structure and features as described above.

The encapsulated file format customization data may be saved on a cloud-based infrastructure. Accordingly, the encapsulated file may include only a link to encapsulated file format customization data hosted on a remote server.

FIG. 3B is a hierarchical structure diagram of the encapsulated video file format, according to some embodiments of the invention. The encapsulated video file format includes multiple media units, each media unit comprised of multiple video frames, each frame comprised of multiple layers: a background static layer, dynamic middle layer and foreground layer.

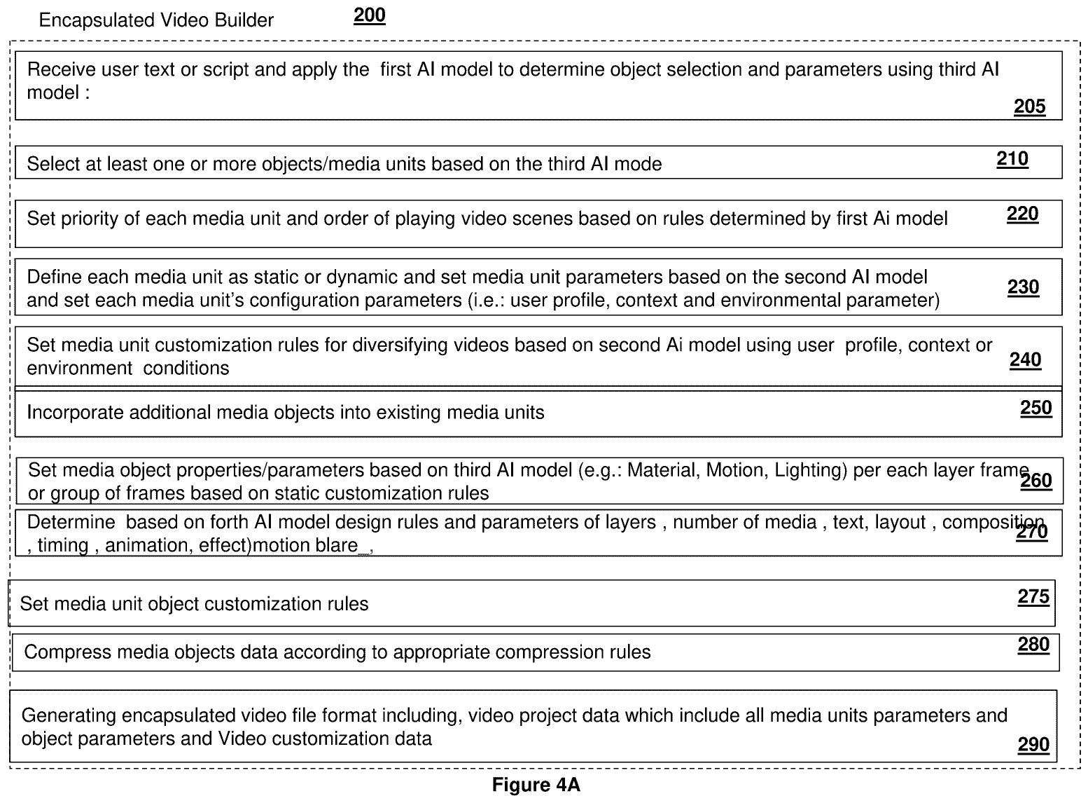

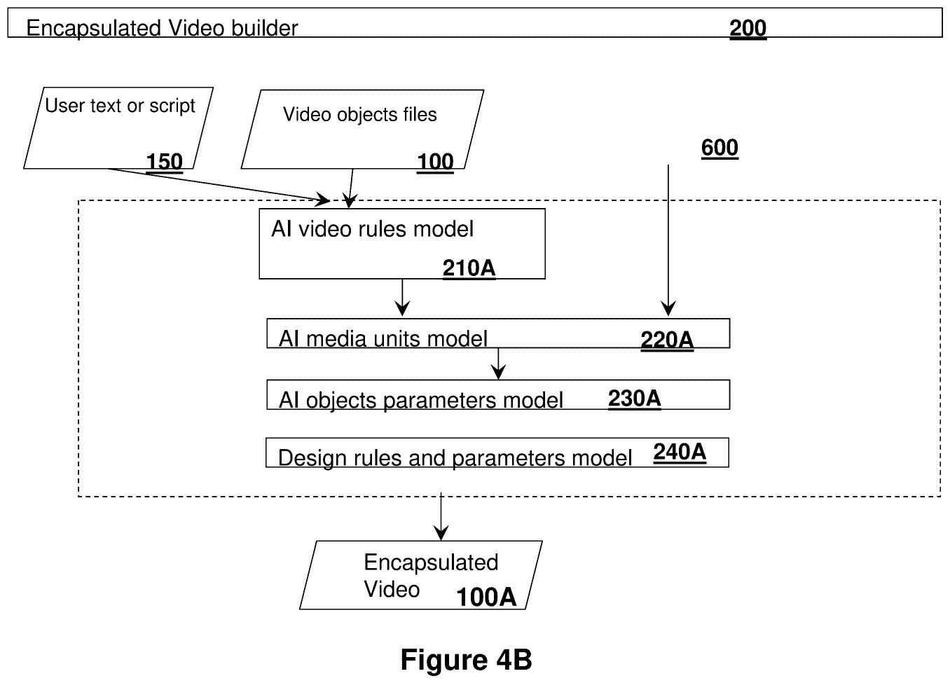

FIG. 4A is a flowchart of a process carried out by the Encapsulated Video Builder module [200], according to some embodiments of the invention. This software module [200] facilitates the generation of Encapsulated Videos, and enables video designers to accomplish at least one of the following actions:
a. Receive user text or script and apply the first AI model to determine object selection and parameters using third AI model (step 205);
b. Select at least one or more objects/media units based on the third AI model and Set priority of each media unit and order of playing video scenes based on rules determined by first Ai model steps 210, 220),
c. define each media unit as either static or dynamic based on the second AI model and set each media unit's configuration parameters (i.e.: user profile, context and environmental parameter, step 230),
d. set each media unit's customization rules (i.e.: dynamic/static properties of the media unit's configuration parameters based on second Ai model, and presentation customization parameters) for diversifying videos based on user profile, context or environment conditions (step 240),
e. incorporate binary data such as additional media objects or links to media objects (e.g. from external source or library) into existing media units (step 250),
f. use third and fourth model of objects parameters and design rules to set media object properties/parameters (e.g.: Material, Motion, Lighting) per each frame or group of frames based on static customization rules set each media object's configuration parameters (e.g.: material, motion, lighting and special effects' parameters) per each frame and layer, wherein the data is indexed by the frame sequence (step 260)
g. use third and fourth model of objects parameters and design rules Set media unit extension features, to globally affect all subsequent media objects parameters, e.g. lighting, shading opacity (step 265)
h. compresses Media objects' data according to predefined rules in relation to the object type (step 27);
i. set each media object's customization rules as static or dynamic for diversifying videos based on user profile, context or environment conditions (step 280), where the static customization rules define customization of object properties during the encapsulation process and the dynamic customization rules define the customization of object properties during the decoding process.
j. Generating encapsulated video file format including video project data which includes all media units' parameters and object parameters and Video customization data. (step 290);

FIG. 4B is a block diagram of an Encapsulated Video Builder module 200, according to some embodiments of the invention. This module includes:
a. a priority organization module 210A for determining media units to be played and the order of playing based on organization and selection rules. These rules are set according to customization parameters, which could be either retrieved from a user's profile, or entered by a user.
b. a preparation module 220A for entering and determining video data by defining or associating configuration parameters and customization rules per each media unit and media object.
c. A generation module 230A for creating encapsulated, encoded video files including video data and video customization data.

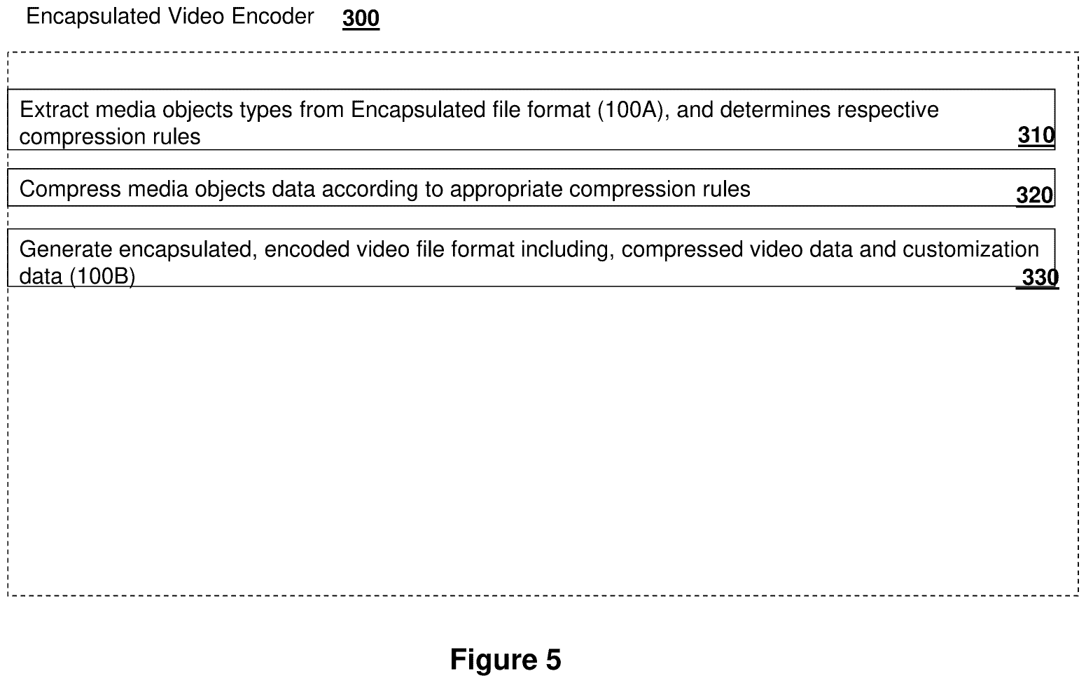

FIG. 5 is a block diagram of an Encapsulated Video Encoder module 300, according to some embodiments of the invention. This module:
a. receives the output of the Encapsulated Video Builder (100A) and determines media objects' compression rules according to their respective types (step 310),
b. compresses Media objects' data according to predefined rules in relation to the object type (step 320),
c. generates an encoded, encapsulated video file format (100B)—(step 330). This type of file could later be played by designated 3rd party video players (900) or using the video decoder-generator unit (400) as diversified video sequences (100C, 100D).
This module is optional, the compression process can take place at the builder module according to some embodiments of the present invention.

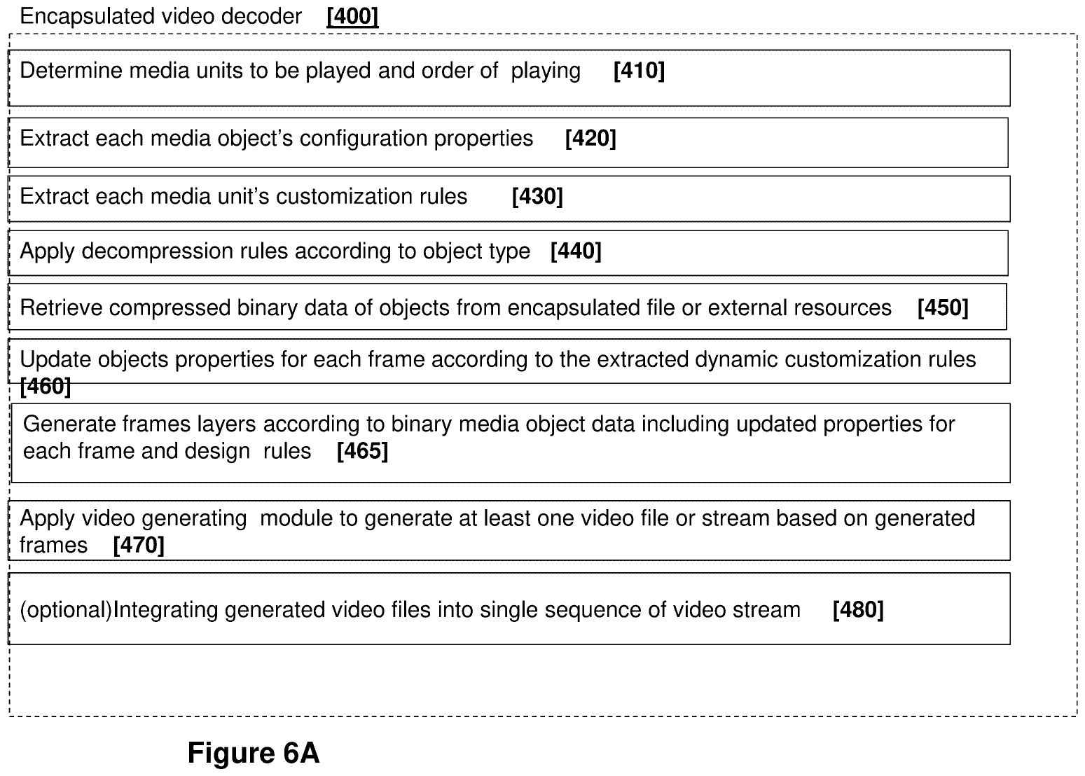

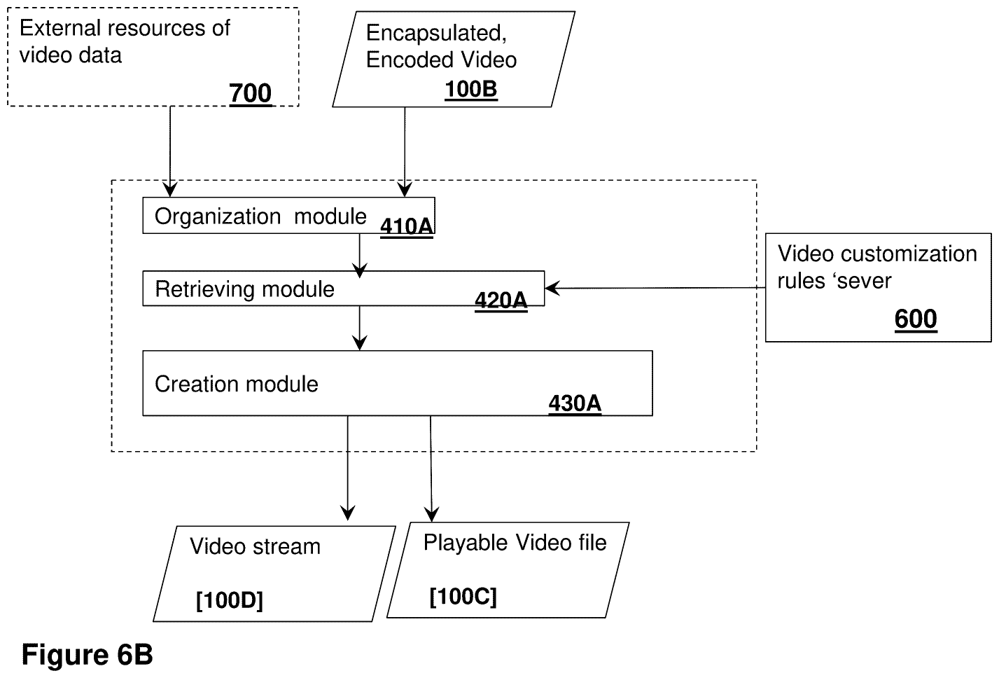

FIG. 6A is a flowchart of a process carried out by an encapsulated video decoder-generator module 400, according to some embodiments of the invention. This module 400, is comprised of at least one of the following steps:
a. Determine media units to be played and order of playing (step 410) based on organization and selection rules. These rules are set according to customization parameters such as environmental or contextual parameters, retrieved from the user's profile or provided by the user.
b. For each media unit, Extract each media object's customization parameters (e.g.: material information, lighting, motion, orientation, visibility)—(step 420)
c. Extract each media unit's customization rules (step 430),
d. Apply decompression rules according to object type (step 440) (optionally is performed before step 420)
e. Retrieve compressed binary data of objects from encapsulated file or external resources (step 450)
f. Update objects' properties for each frame based on dynamic and static customization rules (step 460)
g. Apply design rules and parameters, such as video layers, number of media units, text, layout of objects, composition, timing, animation, effect or motion blare
h. Generate layers of frames according to binary media object data, including updated properties for each frame and the extracted customization rules (step 465)
i. Generate at least one video file from the sequence of generated frames (step 470)
j. Optionally integrate several video files into a single video stream (step 480).

According to some embodiments of the present invention, the customization rules may be dynamic rules updated at the server side in real-time while playing the movie by the user which manages the customized video.

FIG. 6B is a block diagram of an Encapsulated Video decoder-generator module, according to some embodiments of the invention. The Video encapsulation decoder-generator module is comprised of:
a. an organization module 410A for determining the media units to be played and order of playing them based on organization and selection rules using customization parameters retrieved from user profile or entered by the user,
b. a retrieving module 420A for decompressing and extracting media object properties from encapsulated files, retrieving binary data of objects from encapsulated files or external resources, extracting relevant media unit customization rules from the encapsulated files or from a customization video rule sever
c. a creation module for generating at least one video file or stream by applying retrieved customization rules using objects binary data and objects properties based on target user or environment characteristics and/or integrating generated video files into single sequence of video stream.

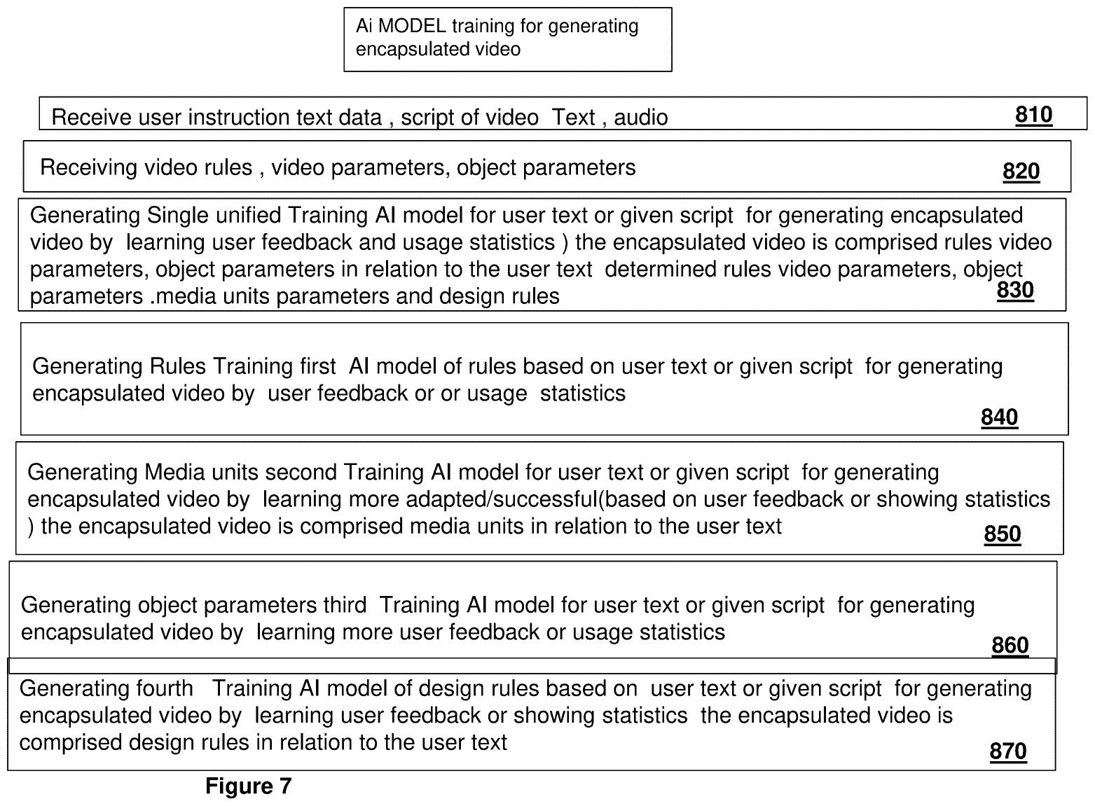

FIG. 7 presents a flowchart diagram outlining a method implemented by an AI model for generating an encapsulated video module. This process is designed in accordance with certain embodiments of the invention, emphasizing a structured approach for video creation and customization.

This module 400, apply of at least one of the following steps:
Receive user instruction text data, script of video Text, audio 810;
Receiving video rules, video parameters, object parameters 820;
There are two implementation options:
1. Single unified Training AI model for user text or given script for generating encapsulated video by learning more adapted/successful (based on user feedback or showing statistics) the encapsulated video is comprised rules video parameters, object parameters in relation to the user text determined rules video parameters, object parameters; 830
2. Using multiple AI model, each model relating to different aspect of the video creation

Training multiple Ai model to generate encapsulated video from user input wherein the encapsulated video is defined by video rules, media unit rules and parameters and object's parameters, wherein each model is trained for different aspect of the of the encapsulated video; 840

Training first AI model for training video rules based on user text or given script for generating encapsulated video by learning more adapted/successful (based on user feedback or showing statistics) the encapsulated video for defining video rules. 840.

Training second Training AI model for training selection of Media units based on user text or given script for generating encapsulated video by learning more adapted/successful (based on user feedback or showing statistics); 850.

Training object parameters third AI model for determining object parameters based on user text or given script for generating encapsulated video by learning user feedback adapted to (based on user feedback or showing statistics) 860;

Training fourth AI model for Determining design layout rules and parameters such as video layers, number of media units, text, layout of objects, composition, timing, animation, effect or motion blare. 870

### Detailed Overview of the Encapsulated Video Module (Module 400)

Module 400 executes a series of steps, each integral to the development of a personalized encapsulated video. These steps include:

### Initial Data Reception (Step 810)

Receiving user instruction: This involves collecting textual data provided by the user, which may include a detailed script for the video or specific textual instructions.
Script processing: The module interprets the script or textual content to understand the context and requirements for the video.
Audio integration: The process includes integrating audio elements as per the user's instructions or script requirements.

### Parameter and Rule Acquisition (Step 830)

Video rules and parameters: The module acquires predefined rules and parameters that dictate the video's structure, style, and format.
Object parameters: This step involves understanding and integrating parameters related to objects within the video, such as characters, items, or backgrounds.

### Single Unified AI Model Training for Script-to-Video Conversion (Step 840)

A single, comprehensive AI model is trained to convert user text or scripts into encapsulated videos.
This model learns to adapt and improve based on user feedback or statistical analysis of successful outcomes.
The generated video encapsulates the defined rules, video parameters, and object parameters, all tailored to the user's text or script.

Using multiple AI model, each model relating to different aspect of the video creation

Training multiple Ai model to generate encapsulated video from user input wherein the encapsulated video is defined by video rules, media unit rules and parameters and object's parameters, wherein each model is trained for different aspect of the of the encapsulated video;

### AI First Model Specialized in Video Rule (Step 850)

This model focuses on applying video rules to the user text or script.
It learns and evolves based on user feedback and user statistics, aiming to create more successful video outcomes.
The encapsulated video produced by this model primarily focuses on the adherence to and integration of video rules and parameters.

### AI First Model Specialized in Media Units.

This model focuses on applying Media units to the user text or script.
It learns and evolves based on user feedback and user statistics, aiming to create more successful video outcomes.
The encapsulated video produced by this model primarily focuses on the adherence to and determination of media units, 850.

### Object Parameter-Focused Third AI Model Training (Step 860)

This step involves training an AI model that specializes in understanding and applying object parameters in relation to the user-provided text or script.
The model is designed to learn from user feedback and success metrics, thereby improving its capability to generate videos that accurately reflect the desired object parameters.

### Design Layout Rules and Parameters Fourth AI Model Training (Step 860)

This step involves training an AI model that specializes in understanding and applying design layout rules and parameters in relation to the user-provided text or script.
The model is designed to learn from user feedback and success metrics, thereby improving its capability to generate videos that accurately reflect the desired design layout rules and parameters.

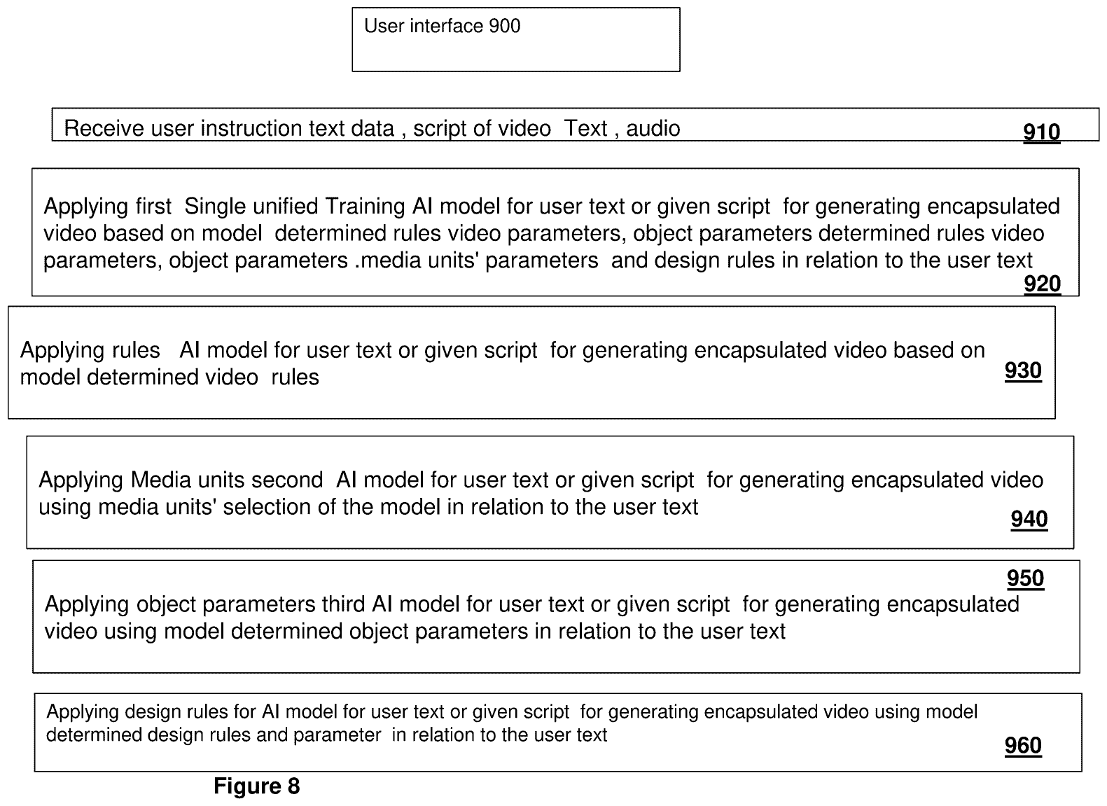

FIG. 8 presents a flowchart diagram outlining a method User interface 900 for generating an encapsulated video module. This process is designed in accordance with certain embodiments of the invention, emphasizing a structured approach for video creation and customization.

This module 900, apply of at least one of the following steps:
Receive user instruction text data, script of video Text, audio, 910;
Applying first Single unified Training AI model for user text or given script for generating encapsulated video based on model determined rules video parameters, object parameters determined rules video parameters, object parameters. media unit's parameters and design rules in relation to the user text; 920
Applying rules AI model for user text or given script for generating encapsulated video based on model determined video rules; 930
Applying Media units second AI model for user text or given script for generating encapsulated video using media units' selection of the model in relation to the user text; 940
Applying object parameters third AI model for user text or given script for generating encapsulated video using model determined object parameters in relation to the user text; 950
Applying design rules for AI model for user text or given script for generating encapsulated video using model determined design rules and parameter in relation to the user text; 960

The system of the present invention may include, according to certain embodiments of the invention, machine readable memory containing or otherwise storing a program of instructions which, when executed by the machine, implements some or all of the apparatus, methods, features and functionalities of the invention shown and described herein. Alternatively, or in addition, the apparatus of the present invention may include, according to certain embodiments of the invention, a program as above which may be written in any conventional programming language, and optionally a machine for executing the program such as but not limited to a general-purpose computer which may optionally be configured or activated in accordance with the teachings of the present invention. Any of the teachings incorporated herein may, wherever suitable, operate on signals representative of physical objects or substances.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

1. A method for generating encapsulated video using AI model implemented by one or more processors operatively coupled to a non-transitory computer readable storage device, on which are stored modules of instruction code that when executed cause the one or more processors to perform the steps of:
training unified Training Ai model to generate encapsulated video from user input wherein the encapsulated video is defined by video rules, media unit rules, and object's parameters and design rules;
applying unified trained AI model to generate encapsulated video based on user input by determining video rules, media unit rules object's parameters and design rules.

2. The method of claim 1 wherein objects parameters including Material object parameters, Motion parameters, Camera positions and/or movement by applying set of camera rules.

3. The method of claim 2 wherein the Selection customization rule includes rules that apply to parameters which determine the media units to be displayed and the order of media unit appearance.

4. The method of claim 2 wherein material parameters including properties of objects including at least one: color, position, visibility, shape, size or orientation.

5. The method of claim 2 wherein Motion parameters are determining motion rules of objects in relation to each video frame or group of frames, wherein the motion rules define route or movement pattern in space.

6. The method of claim 2 wherein the camera rules include Appearance customization rules, Video customization rules, Selection rules of objects or scene, rules that apply to parameters which have a visible effect on the video.

7. The method of claim 2 wherein each media object type may require a different optimal compression rule.

8. A method for generating encapsulated video using AI model implemented by one or more processors operatively coupled to a non-transitory computer readable storage device, on which are stored modules of instruction code that when executed cause the one or more processors to perform the steps of:
training multiple Ai model to generate encapsulated video from user input wherein the encapsulated video is defined by video rules, media unit rules and parameters and object's parameters, wherein each model is trained for different aspect of the of the encapsulated video.
applying trained AI models to generate encapsulated video based on user input by determining video rules, media unit rules and parameters. object's parameters and design rules and parameters.

9. The method of claim 8 wherein one AI model is for training video rules based on user text or given script for generating encapsulated video by learning user feedback or usage statistics.

10. The method of claim 8 wherein one AI model is for training selection of Media units based on user text or given script for generating encapsulated video by learning user feedback or usage statistics.

11. The method of claim 8 wherein one AI model is for object parameters based on user text or given script for generating encapsulated video by learning user feedback or usage statistics.

12. A method for generating encapsulated video using AI model implemented by one or more processors operatively coupled to a non-transitory computer readable storage device, on which are stored modules of instruction code that when executed cause the one or more processors to perform the steps of:
Training first AI model for training video rules based on user text or given script for generating encapsulated video by learning by learning more user feedback.
Training second Training AI model for training selection of Media units based on user text or given script for generating encapsulated video by learning user feedback or usage statistics;
Training object parameters third AI model for object parameters based on user text or given script for generating encapsulated video by learning more user feedback;
Training fourth AI model for Determining design layout rules and parameters including at least one of: video layers, number of media units, text, layout of objects, composition, timing, animation, effect or motion blare
applying trained AI models to generate encapsulated video based on user input by determining video rules, media unit rules and parameters. object's parameters and design rules and parameters.
